(19) United States
(12) Patent Application Publication
(10) Pub. No.: US 2020/0389795 A1
(43) Pub. Date: Dec. 10, 2020

(54) METHOD FOR QUICK CONNECTION TO NETWORK DEVICE

(71) Applicant: GRASTRON TECHNOLOGY CO., LTD., Shenzhen City (CN)

(72) Inventors: KE ZHONG, SHENZHEN CITY (CN); HAOHANG HOU, SHENZHEN CITY (CN); YANGZHI OU, SHENZHEN CITY (CN); YUANZHI NIE, SHENZHEN CITY (CN); ZHAN MENG, SHENZHEN CITY (CN)

(21) Appl. No.: 16/503,951

(22) Filed: Jul. 5, 2019

(30) Foreign Application Priority Data
Jun. 6, 2019 (CN) 201910492453.3

(51) Int. Cl. H04W 12/08; H04W 76/11; H04W 48/08; H04L 29/06

(52) U.S. Cl. CPC H04W 12/0804; H04W 76/11; H04L 63/0853; H04L 63/0428; H04W 48/08

(57) ABSTRACT

The present invention discloses a method for quick connection to a network device, comprising: connecting a setting terminal to the receiving terminal, and configuring a name of a network server of a receiving terminal and a connection password thereof, as well as an IP address of the receiving terminal and an access password thereof; connecting a peripheral device to the receiving terminal, and packaging, encrypting and sending the information to the peripheral device, then connecting the peripheral device to a processing device and running a client program, and connecting the client program to a network where the receiving terminal is located by controlling a network adapter of the processing device to use a name and a connection password of a wireless hotspot; and using the IP address and the access password of the receiving terminal to connect to the body of the receiving terminal.

### FIELD OF THE DISCLOSURE

The present invention relates to a network device connection method, and in particular, to a method for quick connection to a network device.

### BACKGROUND OF THE DISCLOSURE

In the existing network device, a client in a processing device is generally connected to a target device in a network in two steps:

The first step is to first connect this processing device to a network where the target device is located. The first connection generally requires manual setting of a name and a connection password of a wireless or wired network to which a network adapter is connected. The network provided by a network server can be connected only after the name and the password are authenticated by the network server. The second connection generally requires manual switching of the wireless or wired network that has been connected, and the connection is carried out with the name and the connection password of the wireless or wired network automatically saved by the processing device.

The second step is to connect a client of this processing device to a target device server. In general, this client program is first run, and a network connection address and an access password of a target device to which the client is connected are manually input, or a target device list is searched by means of broadcasting, to present all connectable devices. After the connection is clicked, the target device server can be connected only after the access password is input for authentication.

Both authentications require manual setting of the name and the corresponding password. The network connection address and the access password of the target device are tedious and error-prone. Moreover, the connection fails once any one of the network name, the connection password, the connection address of target device network, the access password, etc. is wrong, and re-confirm and re-enter are required.

### SUMMARY OF THE DISCLOSURE

The present invention aims to solve at least one of the technical problems in the related art to some extent. For this purpose, an objective of the present invention is to make the connection of a processing device to a target device more convenient.

A method for quick connection to network device, comprising:

first connecting a setting terminal to a receiving terminal, and configuring a name of a network server of the receiving terminal and a connection password thereof, as well as an IP address of the receiving terminal and an access password thereof.

Further, a peripheral device is connected to the receiving terminal, and after the connection is successful, the receiving terminal packages, encrypts and automatically uploads the pre-configured name of the network server and the connection password thereof, as well as the IP address of the receiving terminal and the access password thereof to the peripheral device.

Further, the peripheral device is disconnected from the receiving terminal, and the peripheral device is connected to the processing device after the disconnection. The client program is run on the processing device. The client program performs the following operations:

Further, the client program will automatically obtain a configuration permission of the network adapter of the processing device, automatically match the network server name pre-stored on the peripheral device, such as the wireless hotspot name, in a list of connectable networks within the current search range of the network adapter, find out a same target network name as the network server name, and then automatically write the connection password pre-stored on the peripheral device to a network key input window corresponding to the target network name, and connect the processing device to a network server where the receiving terminal is located after the writing is completed.

Further, the client program will obtain the IP address and the access password of the receiving terminal pre-stored on the peripheral device, find out the IP address by means of a network established by the network server, and automatically input the access password to establish a connection with the body of the receiving terminal.

The present invention has the following advantageous effects:

1. The peripheral device, as a carrier of the network server name and the connection password, is connected to the processing device, and then performs an automatic connection operation on the network server name and password stored in the peripheral device by means of a client program, so that a user no longer searches hotspot names and inputs connection password when using the processing device or when connecting to a network server where the receiving terminal is located. The simple, fast and accurate automatic connection mode makes the application of the client program better.

2. The peripheral device, as a carrier of the IP address and the access password of the receiving terminal, is connected to the processing device, and then performs an automatic connection operation on the IP address and the password of the receiving terminal stored in the peripheral device by means of the client program, so that the user does not have to manually find a target receiving terminal and input a correct access password for operation when using the processing device or connecting to the receiving terminal over a network, which ensures the unauthorized access, and the simpler, faster and more accurate automatic connection mode makes the application of the client program better.

### BRIEF DESCRIPTION OF THE DRAWINGS

To illustrate the technical solutions in embodiments of the present invention or the prior art more clearly, the drawings used in the description of the embodiments or the prior art are briefly described below. Apparently, the drawings in the following description are only some embodiments of the present invention, and those skilled in the art can also obtain other drawings according to the structures shown in these drawings without involving any inventive effort.

FIG. 1 is a network connection method for a wireless multimedia conference system according to an embodiment of the present invention; and

FIG. 2 is a schematic diagram of an implementation environment according to an embodiment of the present invention.

### DETAILED DESCRIPTION OF THE EXEMPLARY EMBODIMENTS

The technical solutions in the embodiments of the present invention are clearly and completely described below with reference to the drawings in the embodiments of the present invention. Apparently, the described embodiments are only a part of the embodiments of the present invention, but not all embodiments.

All other embodiments obtained by those skilled in the art based on the embodiments of the present invention without involving an inventive effort are within the scope of protection of the present invention.

It should be noted that all directional indications (such as up, down, left, right, front, back, inner, outer, center, . . . ) in the embodiments of the present invention are only used to explain the relative positional relationship, motion, etc. between components in a certain particular attitude (as shown in the drawing). If the particular attitude changes, the directional indication also changes accordingly.

In the present invention, unless otherwise specified and defined, the terms “connected”, “fixed”, etc. should be comprehended in a broad sense. For example, “fixed” may be comprehended as being fixedly connected, detachably connected or integrally connected; mechanically connected or electrically connected; or directly connected or indirectly connected through an intermediate medium, or in an internal communication between two elements or an interaction relationship of two elements, unless otherwise defined. The specific meanings about the foregoing terms in the present invention may be understood for those skilled in the art according to specific circumstances.

In addition, the technical solutions between the embodiments of the present invention may be combined with each other provided that the combined technical solutions can be realized by those skilled in the art. If the combination of the technical solutions is contradictory or impossible to implement, the combination of the technical solutions does not exist and is not within the scope of protection of the present invention.

### Embodiment 1

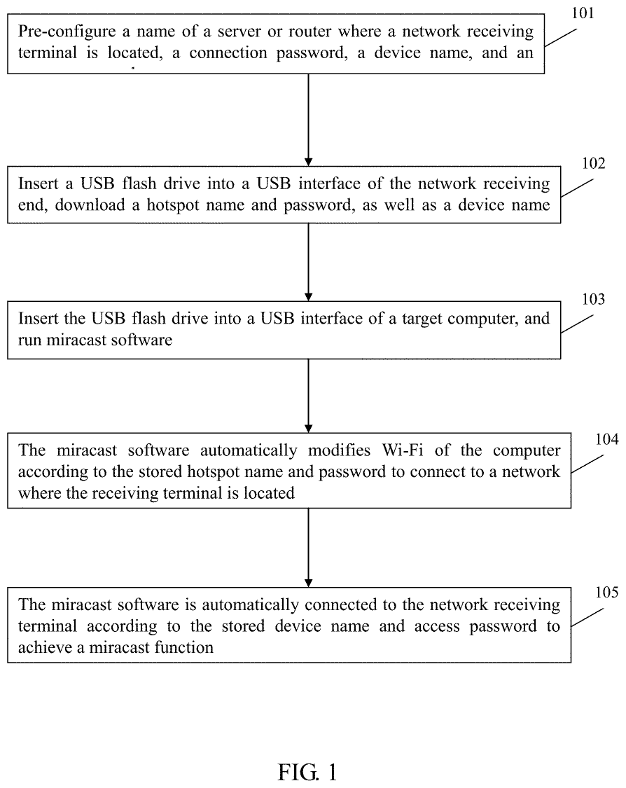

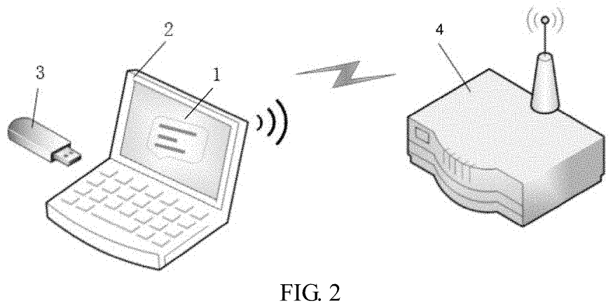

As shown in FIGS. 1-3, a wireless multimedia conference system using a method for quick connection to a network device includes five devices, i.e., a setting terminal, a processing device, a peripheral device, a target device, and a network server.

Further preferably, the setting terminal in this embodiment is preferably configuration software 1.

Further preferably, the processing device in this embodiment is preferably a computer 2.

Further preferably, the peripheral device in this embodiment is preferably a USB flash drive 3 in which a client program is stored. In this embodiment, the client program is preferably miracast software.

Further preferably, the target device in this embodiment is preferably a wireless receiving terminal 4. The wireless receiving terminal 4 includes at least one set of USB interfaces. In this embodiment, the target device may be equivalent to a projector or a television having a wireless routing function.

Further preferably, the network server in this embodiment is preferably a hotspot of the wireless receiving terminal 3.

The connection method of the wireless multimedia conference system in this embodiment is as follows:

Step 101: an initial hotspot name and a connection password of the wireless receiving terminal 3, as well as a device name and an access password are configured after the configuration software is connected to the wireless receiving terminal 4.

Step 102: the USB flash drive 3 is inserted into a USB interface of the wireless receiving terminal 4, the hotspot name and the password stored in the wireless receiving terminal 4, as well as the device name and the access password are downloaded, and the USB flash drive 3 is unplugged after the download is completed.

Step 103: the USB flash drive 2 is inserted into a USB interface of the computer 2, a file in the USB flash drive 3 is clicked to open, and the miracast software stored in the file is clicked and run.

Step 104: a WiFi hotspot to which a target computer 1 is currently connected is automatically switched to a WiFi hotspot transmitted by the wireless receiving terminal 3 by using the miracast software according to the hotspot name and password pre-stored in the USB flash drive 3, thereby connecting to a network server where the wireless receiving terminal 3 is located.

Step 105: the miracast software is automatically connected to the wireless receiving terminal 3 according to the target device name and access password pre-stored in the USB flash drive 3. A video file or data is sent to the wireless receiving terminal 3 by means of the miracast software after the connection is successful, and the wireless receiving terminal 3 projects the video file or data on a large screen.

In this embodiment, the miracast software implements two functions. One function is that an auxiliary computer 2 is connected to a gateway where the wireless receiving terminal 4 is located, so that the computer 2 is connected to the network. The other function is that the auxiliary computer 2 is connected to the body of the wireless receiving terminal 4 for controlling the wireless receiving terminal 4 to implement the miracast function. The conference system effectively saves the time for connecting the network and the device for the user, thereby effectively improving the efficiency.

### Embodiment 2

Embodiment 2 differs from Embodiment 1 in that the computer 2 is indirectly connected to the wireless receiving terminal 4, the computer 2 is connected to a third-party router in a wireless manner, and the receiving terminal is also connected to the third-party router in a wired or wireless manner. In an application method of this embodiment, the miracast software implements two functions. One function is that the auxiliary computer 2 is connected to the third-party router, so that the computer 2 establishes a network communication to a network where the wireless receiving terminal 4 is located. The other function is that the computer 2 performs search matching by using the device name and the access password pre-stored in the U flash drive 3, and the computer 2 is connected to the body of the wireless receiving terminal 3 to control the wireless receiving terminal 3 to implement the miracast function.

### Embodiment 3

Embodiment 3 differs from Embodiment 1 in that the processing device is preferably a mobile smart device, including, but not limited to, a mobile phone, a tablet computer, and a smartwatch.

### Embodiment 4

Embodiment 4 differs from Embodiment 1 in that the wireless receiving terminal may be a wireless router with a read/write function.

The above are only preferred embodiments of the present invention, and are not intended to limit the present invention. Various modifications and changes can be made to the present invention for those skilled in the art. Any modifications, equivalent substitutions, improvements, etc. made within the spirit and principle of the present invention should be included within the scope of protection of the present invention.

What is claimed is:

1. A method for quick connection to a network device, comprising:
first connecting a configuration terminal to a receiving terminal, and configuring a name of a network server where the receiving terminal is located and a connection password thereof, as well as an IP address of the receiving terminal and an access password thereof, wherein the name of the network server comprises, but is not limited to, a name of an external third-party wireless server or a router hotspot to which the receiving terminal is connected in a wired or wireless mode, or a name of a wireless hotspot transmitted by the receiving terminal itself; and
then connecting a peripheral device to the receiving terminal, and packaging, encrypting and automatically uploading, by the receiving terminal, the pre-configured name of the network server and the connection password thereof, as well as the IP address of the receiving terminal and the access password thereof to the peripheral device after the connection is successful.

2. The method for quick connection to a network device according to claim 1, further comprising: disconnecting the peripheral device from the receiving terminal, and connecting the peripheral device to the processing device after the disconnection; and running the client program on the processing device, wherein the client program performs at least one or more of the following operations:
1) the client program will automatically obtain a configuration permission of the network adapter of the processing device, automatically match the network server name pre-stored on the peripheral device, such as the wireless hotspot name, in a list of connectable networks within the current search range of the network adapter, find out a same target network name as the network server name, and then automatically write the connection password pre-stored on the peripheral device to a network key input window corresponding to the target network name, and connect the processing device to a network server where the receiving terminal is located after the writing is completed; and
2) the client program will use the obtained IP address and the access password of the receiving terminal pre-stored on the peripheral device, find out the IP address, and automatically input the access password to establish a connection with the body of the receiving terminal.

3. The method for quick connection to a network device according to claim 1, wherein the peripheral device needs to reconnect to the receiving terminal after the receiving terminal reconfigures the IP address, the access password, the network server name, and the connection password; and after the connection is completed, the receiving terminal will automatically overwrite the IP address, the access password, the wireless hotspot name, and the connection password previously stored on the peripheral device with the updated IP address, access password, network server name, and connection password, wherein the peripheral device refers to a mobile storage device with a read/write function.
